(19) United States
(12) Patent Application Publication
(10) Pub. No.: US 2021/0116632 A1
(43) Pub. Date: Apr. 22, 2021

(54) LIGHT SOURCE UNIT AND DISPLAY APPARATUS

(71) Applicant: Sakai Display Products Corporation, Sakai City, Osaka (JP)

(72) Inventor: KOHEI NANBU, Sakai City (JP)

(21) Appl. No.: 16/324,908

(22) PCT Filed: Aug. 12, 2016
(86) PCT No.: PCT/JP2016/073777

§ 371 Date: Apr. 11, 2019

(51) Int. Cl. F21V 8/00

(52) U.S. Cl. CPC G02B 6/0078; G02B 6/0073

(57) ABSTRACT

Provided are a light source unit and a display apparatus that are capable of improving the reliability of a display panel from the viewpoint of damage. This light source unit is provided with: a light source; and a light guide unit to which a plurality of elongated light guide bodies having end surfaces on which light from the light source is made incident are provided in parallel, wherein the end surfaces of the light guide bodies are arranged along a prescribed arc on a plane vertical to the longitudinal direction of the light guide bodies.

### TECHNICAL FIELD

The present invention relates to a light source unit and a display apparatus.

### BACKGROUND ART

In recent years, liquid-crystal displays (LCDs), which are representatives of flat panel displays, have been widely used not only in the field of small-size or medium-size display panels but also in the field of large-size display panels. Making large-size display panels mountable on curved walls as well as flat walls can provide more choices of the installation place of the display panels. Display panels can add more reality or visibility by being curved. Therefore, there is an increasing demand for curved display panels.

Patent Literature 1 discloses a light source device as an edge-lit backlight source for a curved display. In the light source device, light emitting regions including a plurality of light emitting elements are arranged along a curved shape of an end surface of a light guide plate.

### CITATION LIST

### Patent Literature

### [Patent Literature 1]

Japanese Patent Application Laid-Open Publication No. 2015-50108

### SUMMARY OF INVENTION

### Technical Problem

However, in the case of a curved light guide plate with two deflected opposing edges (for example, long edges), such as the light guide plate of the device disclosed in Patent Literature 1, the light guide plate stretches along a curvature direction of the long edges due to thermal expansion, and an outer surface of the light guide plate also stretches in a thickness direction of the light guide plate due to thermal expansion. Consequently, the light guide plate presses a display panel disposed facing the outer surface of the light guide plate to exert local stress on the display panel, increasing the possibility that the display panel is damaged.

The present invention has been made in view of the circumstances described above, and an object thereof is to provide a light source unit capable of increasing reliability of a display panel in terms of damage prevention and a display apparatus including such a light source unit.

### Solution to Problem

A light source unit according to an embodiment of the present invention includes a light source section and a light guide unit including a plurality of elongated light guides arranged side-by-side. The light guides have end surfaces through which light from the light source section enters the light guides. The end surfaces of the light guides are arranged along a specific arc on a plane orthogonal to a long edge direction of the light guides.

A display apparatus according to an embodiment of the present invention includes the light source unit according to an embodiment of the present invention and a display panel curved along the specific arc.

### Advantageous Effects of Invention

According to an embodiment of the present invention, it is possible to increase reliability of a display panel in terms of damage prevention.

### BRIEF DESCRIPTION OF DRAWINGS

FIG. 1 is a partial perspective view illustrating an example of a configuration of a display apparatus according to an embodiment of the present invention.

FIG. 2 is a partial perspective view illustrating an example of a configuration of a light guide unit according to the embodiment of the present invention.

FIG. 3 is a partial perspective view illustrating an example of a conventional backlight source including a light guide plate as a comparative example.

FIG. 4 is an explanatory diagram illustrating an example of arrangement of a light source section of a light source unit according to the embodiment of the present invention.

FIG. 5 is an explanatory diagram illustrating a first example of a form of attachment of light guides according to the embodiment of the present invention.

FIG. 6 is an explanatory diagram partially illustrating a chassis according to the embodiment of the present invention.

FIG. 7 is a cross-sectional view illustrating an attached state of one light guide, taken along a plane orthogonal to a long edge direction of the light guides according to the embodiment of the present invention.

FIG. 8 is an explanatory diagram illustrating a second example of entry of light into the light guides according to the embodiment of the present invention.

FIG. 9 is an explanatory diagram illustrating a third example of entry of light into the light guides according to the embodiment of the present invention.

### DESCRIPTION OF EMBODIMENTS

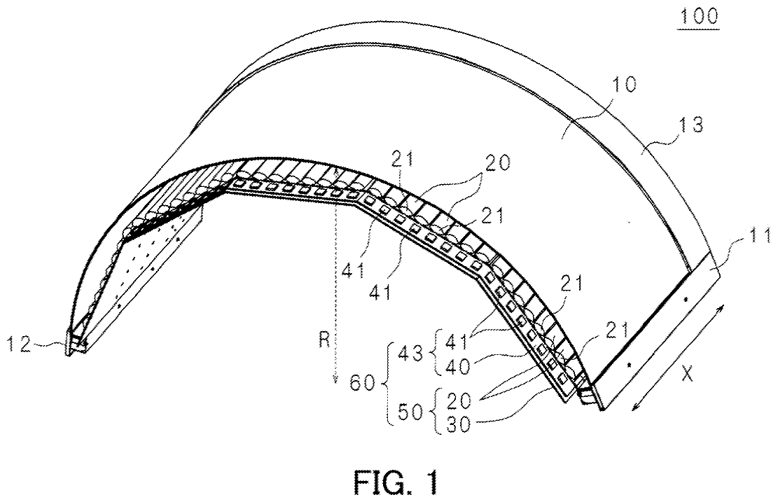

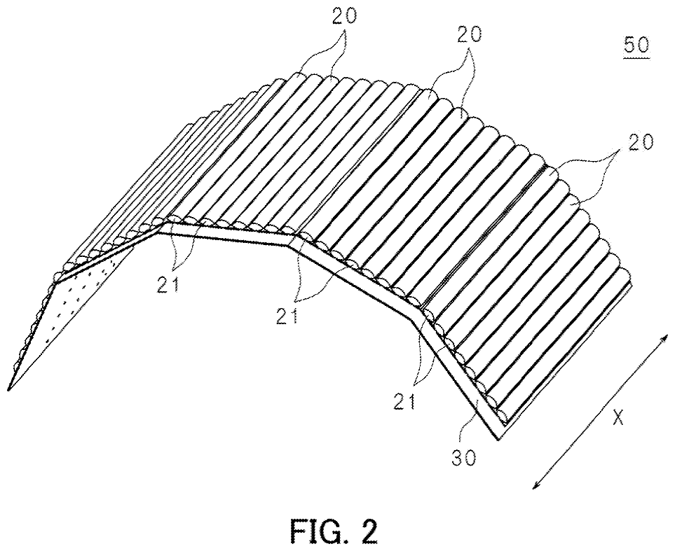

The following describes the present invention based on the drawings illustrating an embodiment of the present invention. FIG. 1 is a partial perspective view illustrating an example of a configuration of a display apparatus 100 according to the present embodiment. FIG. 2 is a partial perspective view illustrating an example of a configuration of a light guide unit 50 according to the present embodiment. Note that FIG. 2 shows a plurality of light guides 20 and a chassis 30 described below and omits other elements for convenience of illustration. As illustrated in FIG. 1, the display apparatus 100 includes elements such as a display panel 10 for displaying images (including pictures), the light guide unit 50, and frame members 11, 12, and 13 surrounding the display panel 10, the light guide unit 50, and the like. The light guide unit 50 includes the light guides 20, the chassis 30, and the like.

The display panel 10 includes elements such as a liquid crystal layer, two light transmissive glass substrates holding the liquid crystal layer therebetween, and a pair of polarizing plates disposed on the outside of the two glass substrates, respectively, none of which are shown. Light from a light source unit 60 is controlled in the display panel 10, and thus the display apparatus 100 can display a specific image.

The light source unit 60 includes a light source section 43 including a substrate 40 and a plurality of LEDs 41, and the light guide unit 50 including the chassis 30 and the light guides 20 having end surfaces 21 through which light from the LEDs 41 of the light source section 43 enters the light guides 20. The light guides 20 have an elongated shape, and are arranged side-by-side and fixed to the chassis 30. The light source section 43 is also fixed to the chassis 30 as in the light guides 20. A surface of the chassis 30 faces the light guides 20 and is provided with a reflection sheet 31 described below.

Examples of materials of the light guides 20 include, but are not limited to, transparent resins such as acrylic resin and polycarbonate. A metal plate such as of an aluminum alloy, iron, or stainless steel may for example be used as the chassis 30.

The substrate 40 is flexible, being made from a plastic material such as polyimide and polyester (PET). The substrate 40 is a so-called flexible board. The LEDs 41 are capable of emitting white light.

The term “arc” used in the present description encompasses not only a portion (a curve) of a circle but also a polyline being a portion of a polygonal shape circumscribing an arc. That is, the term “a specific arc” can mean “a specific arc or a polyline circumscribing a specific arc”.

As illustrated in FIG. 2, the light guides 20 are elongated in the same long edge direction, and the chassis 30 is bent as if wrapping around a circumference of a cylinder whose height direction is parallel to the long edge direction (a direction indicated by reference sign X in FIGS. 1 and 2) of the light guides 20. That is, a cross-section of the chassis 30 taken along a plane orthogonal to the long edge direction of the light guides 20 is a polyline circumscribing a circle representing a side surface of the cylinder. Since the light guides 20 are fixed to the chassis 30, the end surfaces 21 of the light guides 20 are arranged along a specific arc on the plane orthogonal to the long edge direction of the light guides 20. Note that the shape of the end surfaces 21 of the light guides 20 is not limited to the shape shown in the drawings. The number of the light guides 20 in the light guide unit 50 is not limited to the number shown in the drawings.

In FIGS. 1 and 2, the chassis 30 has a form of a flat plate bent at four locations. Alternatively, the chassis 30 may have a form including a smoothly curved surface such as a side surface of a cylinder. In this case, the light guides 20 are fixed to the curved surface, and accordingly the end surfaces 21 of the light guides 20 are arranged along a specific arc.

One pair of two opposing edges of the display panel 10 are long edges, and another pair of two opposing edges are short edges. According to the present embodiment, as illustrated in FIG. 1, the display panel 10 is curved such that the long edges of the display panel 10 are curved along the specific arc, and the display panel 10 and the light guide unit 50 are disposed to face each other such that the long edge direction of the light guides 20 matches a short edge direction (reference sign X in FIG. 1) of the display panel 10.

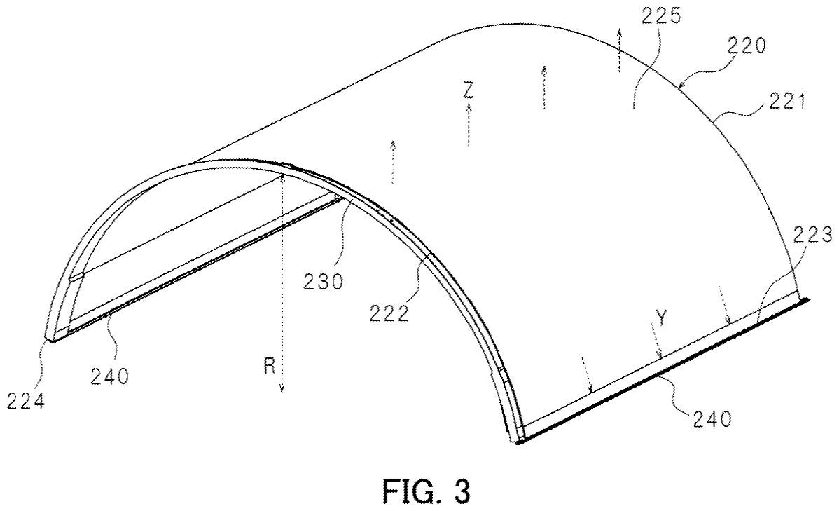

FIG. 3 is a partial perspective view illustrating an example of a conventional backlight source including a light guide plate as a comparative example. The conventional backlight source includes a light guide plate 220, a light source section 240, a frame member 230, and the like. Note that FIG. 3 omits other elements for convenience of illustration. The light guide plate 220 has a rectangular shape defined by two opposing long edges 221 and 222 and two opposing short edges 223 and 224. The light guide plate 220 is curved with the long edges 221 and 222 deflected according to curvature of a curved display panel (not shown). A curvature radius of the curved light guide plate 220 is represented by reference sign R in FIG. 3.

The light source section 240 includes elongated substrates having a length that is substantially equal to a length of the short edges 223 and 224 of the light guide plate 220, and a plurality of LEDs mounted on a surface of each substrate. Light from the LEDs enters through elongated end surfaces of the light guide plate 220 along the short edges 223 and 224. The backlight source illustrated in FIG. 3 is what may be referred to as a two-short-edge-lit backlight source.

The light guide plate 220 of the conventional backlight source stretches along a curvature direction (reference sign Y in FIG. 3) of the long edges thereof due to thermal expansion, and an outer surface 225 of the light guide plate 220 also stretches in a thickness direction (reference sign Z in FIG. 3) of the light guide plate 220 due to thermal expansion. Consequently, the light guide plate 220 presses the display panel (not shown) disposed facing the outer surface 225 of the light guide plate 220 to exert local stress on the display panel, increasing the possibility that the display panel is damaged. Furthermore, as a result of the light guide plate 220 stretching along the curvature direction of the long edges thereof due to thermal expansion, the short edges 223 and 224 of the light guide plate 220 for example press the LEDs of the light source section 240, increasing the possibility that the LEDs are damaged.

By contrast, according to the present embodiment, the light guides 20 forming the light guide unit 50 have an elongated shape. An amount of stretching of the light guides 20 in a radial direction thereof due to thermal expansion is smaller than an amount of stretching of the outer surface 225 of the conventional light guide plate 220 in the thickness direction of the light guide plate 220. It is therefore possible to prevent the display panel 10 from being pressed by the light guide unit 50. As described above, the display panel 10 according to the present embodiment is free of local stress, and is therefore prevented from damage. That is, the present embodiment increases reliability of the display panel in terms of damage prevention.

Since the amount of stretching of the light guides 20 in the radial direction due to thermal expansion is smaller than the amount of stretching of the outer surface 225 of the conventional light guide plate 220 in the thickness direction of the light guide plate 220, the present embodiment can achieve a shorter distance between the light guide unit 50 and the display panel 10, allowing the display apparatus 100 to be thinner. The present embodiment can also reduce luminance variation on a display surface of the display panel 10 by achieving a shorter distance between the light guide unit 50 and the display panel 10.

Furthermore, since the end surfaces 21 of the light guides 20 are arranged along the specific arc on the plane orthogonal to the long edge direction of the light guides 20, the light source unit 60 can be applied to any curved display panel 10 by appropriately adjusting the curvature radius or the shape of the specific arc according to the curvature radius of the display panel 10. The display apparatus 100 according to the present embodiment can therefore include a display panel having a desired curvature radius.

In order to design the backlight source including the light guide plate 220 curved as illustrated in FIG. 3 with consideration of stretching of the light guide plate 220 due to thermal expansion, it is necessary to take into consideration not only stretching of the outer surface 225 of the light guide plate 220 in the thickness direction but also stretching of the light guide plate 220 in the curvature direction. Such a conventional configuration may therefore limit design freedom for the backlight source. By contrast, the present embodiment enables designing with little consideration of stretching of the light guides 20 toward the display panel 10 due to thermal expansion or stretching of the light guides 20 in the curvature direction of the display panel 10 due to thermal expansion, because the end surfaces 21 of the light guides 20 are arranged along the specific arc on the plane orthogonal to the long edge direction of the light guides 20. That is, the present embodiment can increase design freedom for the light source unit, requiring that only stretching of the light guides 20 in the long edge direction be considered.

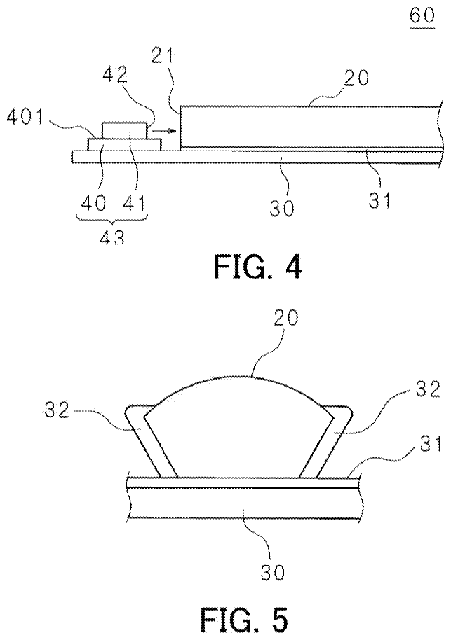

The following describes the light source section. FIG. 4 is an explanatory diagram illustrating an example of arrangement of the light source section 43 of the light source unit 60 according to the present embodiment. As illustrated in FIGS. 1 and 4, the light source section 43 includes the flexible substrate 40 curved along the arc and the LEDs 41 mounted on a convex surface of the curved substrate 40. As described above, the substrate 40 of the light source section 43 is fixed to the chassis 30. The substrate 40 has a form of a flat plate bent at four locations as illustrated in FIG. 1. Alternatively, where the chassis 30 has a form including a smoothly curved surface such as a side surface of a cylinder, the substrate 40 may have a similar form including a curved surface.

Since the substrate 40 is flexible, the degree of curvature thereof is freely changeable. It is therefore unnecessary to prepare a new substrate depending on the curvature radius (reference sign R in FIG. 1) of the curved display panel 10.

As illustrated in FIG. 4, each of the LEDs 41 has a light emitting surface 42 orthogonal to a curved surface 401 of the curved substrate 40. The LEDs 41 are disposed with the light emitting surfaces 42 facing the end surfaces 21 of the light guides 20. The curved surface 401 may be the convex surface (outer surface) or a concave surface (inner surface), which is a surface opposite to the convex surface (opposite surface), of the curved substrate 40. That is, the LEDs 41 may be disposed on either the convex surface or the opposite concave surface of the curved substrate 40 depending on the arrangement of the light guides 20 and the substrate 40. Thus, the present embodiment can increase design freedom for the light source unit 60. Note that the curved surface 401 is the convex surface (outer surface) of the curved substrate 40 in the example illustrated in FIG. 1. In the configuration in which the LEDs 41 are mounted on the convex surface of the curved substrate 40, the substrate 40 is directly fixed to the surface of the chassis 30. In a configuration in which the LEDs 41 are mounted on the concave surface of the curved substrate 40, however, the substrate 40 needs to be fixed to the chassis 30 with the LEDs 41 located between the concave surface of the substrate 40 and the surface of the chassis 30. The LEDs 41 are so-called side emitting LEDs each having the light emitting surface 42 orthogonal to the curved surface 401 of the substrate 40.

As including the side emitting LEDs 41, the present embodiment can be applied to various display panels 10 each having a different curvature radius, because the LEDs 41 can be disposed with the light emitting surfaces 42 facing the end surfaces 21 of the light guides 20 by only changing the degree of curvature of the flexible substrate 40 depending on the curvature radius of the desired display panel 10.

The following describes a form of attachment of the light guides 20 to the chassis 30. FIG. 5 is an explanatory diagram illustrating a first example of the form of attachment of the light guides 20 according to the present embodiment. FIG. 5 is a cross-sectional view taken along the plane orthogonal to the long edge direction of the light guides 20. Clip pairs are fixed to the surface of the chassis 30 with the reflection sheet 31. Each of the clip pairs includes two opposing clip members 32 arranged in a short edge direction of the corresponding light guide 20 with a specific distance therebetween and is fixed at a plurality of locations aligned in the long edge direction of the light guide 20. No particular limitations are placed on the material of the clip members 32 so long as restoring force that moves the clip members 32 in each pair toward each other is generated when force that moves the clip members 32 away from each other is exerted. The specific distance can be determined according to the shape of the light guides 20 so as to be long enough for each clip pair to hold the corresponding light guide 20. The light guide 20 can be fixed to the chassis 30 by being pushed down into a space between the pair of clip members. The use of the clip pairs allows the light guides 20 to be easily arranged side-by-side at predetermined intervals and fixed to the chassis 30. The shape of the clip members 32 is not limited to what is shown in FIG. 5 so long as restoring force that moves the clip members 32 in each pair toward each other is generated.

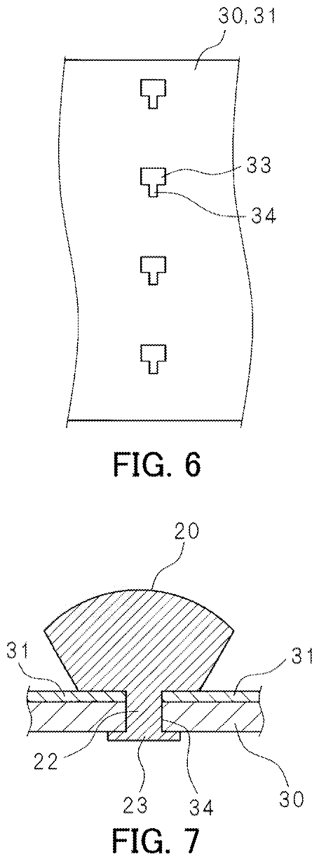

The following describes a second example of the form of attachment of the light guides 20. FIG. 6 is an explanatory diagram partially illustrating the chassis 30 according to the present embodiment. FIG. 7 is a cross-sectional view illustrating an attached state of one of the light guides 20, taken along the plane orthogonal to the long edge direction of the light guides 20 according to the present embodiment. As illustrated in FIG. 6, a plurality of mating holes are formed in the chassis 30 in the long edge direction of the light guides 20. Each of the mating holes for example has a shape including a large-width rectangular hole 33 and a small-width rectangular hole 34 joined together. Note that FIG. 6 is not a full-scale illustration but an enlarged illustration of the mating holes for convenience of illustration.

As illustrated in FIG. 7, each light guide 20 has protrusions that mate with the mating holes of the chassis 30. Each of the protrusions includes a first protrusion 22 having substantially the same width as the hole 34, and a second protrusion 23 extending from the first protrusion 22 and having substantially the same width as the hole 33. The second protrusion 23 is inserted in the corresponding hole 33, and then moved toward the corresponding hole 34, so that the first protrusion 22 can mate with the hole 34, and the chassis 30 (reflection sheet 31) can be held between the second protrusion 23 and a main body (a part other than the first and second protrusions 22 and 23) of the light guide 20. Through the above, the light guide 20 can be fixed to the chassis 30. Such a configuration allows the light guides 20 to be easily arranged side-by-side at predetermined intervals and fixed to the chassis 30.

Another example, not shown, of the form of attachment of the light guides 20 is to attach the light guides 20 to the chassis 30 (reflection sheet 31) with double sided tape.

The following describes entry of light into the light guides 20. The above-described example has a configuration in which the light guide unit 50 includes the elongated light guides 20 arranged side-by-side, and the LEDs 41 are disposed at one of two ends of the light guide unit 50 in the long edge direction of the light guides 20 to cause light from the LEDs 41 to enter through the end surfaces 21 facing in the same direction. However, entry of light into the light guides 20 is not limited to such an example.

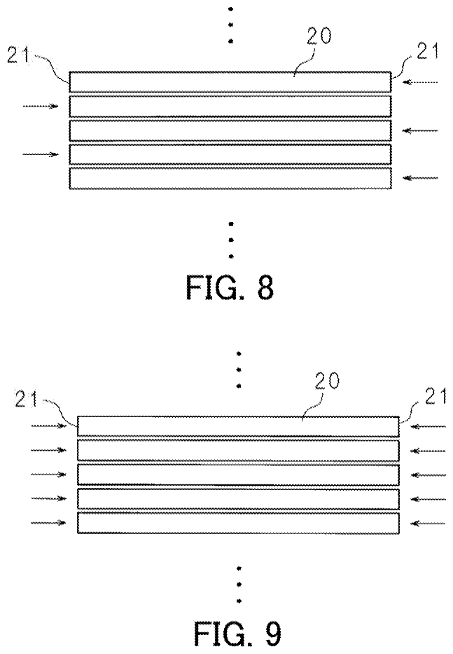

FIG. 8 is an explanatory diagram illustrating a second example of entry of light into the light guides 20 according to the present embodiment. Arrows in FIG. 8 represent light that enters through the end surfaces 21. In the example illustrated in FIG. 8, the end surface 21 of each light guide 20 through which LED light enters and the end surface 21 of an adjacent light guide 20 through which LED light enters are at different ends of the light guide unit 50 including the light guides 20 arranged side-by-side. As such, one of two end surfaces of each light guide 20 faces an LED. That is, an LED is disposed at one of the two longitudinal ends of each light guide 20. Such a configuration ensures that LED light can enter through one of the end surfaces 21 of each light guide 20 even in a situation in which an interval (pitch) between adjacent light guides 20 is smaller than an interval (pitch) between adjacent LEDs, while the light guides 20 or the LEDs may be available in various shapes or sizes.

FIG. 9 is an explanatory diagram illustrating a third example of entry of light into the light guides 20 according to the present embodiment. Arrows in FIG. 9 represent light that enters through the end surfaces 21. In the example illustrated in FIG. 9, LED light enters each light guide 20 through both of the two end surfaces 21 of the light guide 20 at the two respective ends of the light guide unit 50 including the light guides 20 arranged side-by-side. As such, the two end surfaces of each light guide 20 respectively face LEDs. That is, LEDs are respectively disposed at both of the two longitudinal ends of each light guide 20. As the light guides 20 may be available in various lengths, or LED light may be available in various intensities, the configuration in which LED light enters the light guides 20 through the end surfaces 21 facing in the same direction may not be able to irradiate the display panel 10 with sufficient light. Even in such a situation, the configuration illustrated in FIG. 9 ensures that the display panel 10 can be irradiated with sufficient light by causing light from the LEDs 41 to enter each light guide 20 through both of the two end surfaces 21 of the light guide 20.

The light source unit according to the present embodiment includes the light source section and the light guide unit including the elongated light guides arranged side-by-side. The light guides have end surfaces through which light from the light source section enters the light guides. The end surfaces of the light guides are arranged along the specific arc on the plane orthogonal to the long edge direction of the light guides.

In the light source unit, the end surfaces of the light guides are arranged along the specific arc on the plane orthogonal to the long edge direction of the light guides. The term “arc” encompasses not only a portion (a curve) of a circle but also a polyline being a portion of a polygonal shape circumscribing an arc.

One pair of two opposing edges of the display panel are long edges, and another pair of two opposing edges are short edges, for example. The display panel is curved such that the long edges of the display panel are curved along the specific arc, and the display panel and the light guide unit are disposed to face each other such that the long edge direction of the light guides matches the short edge direction of the display panel. The light guides forming the light guide unit have an elongated shape. The amount of stretching of the light guides in the radial direction thereof due to thermal expansion is smaller than the amount of stretching of the outer surface of the conventional light guide plate in the thickness direction of the light guide plate. It is therefore possible to prevent the display panel from being pressed by the light guide unit. As described above, the display panel is free of local stress, and is therefore prevented from damage. That is, it is possible to increase reliability of the display panel in terms of damage prevention.

Since the amount of stretching of the light guides in the radial direction due to thermal expansion is small, the present embodiment can achieve a shorter distance between the light guide unit and the display panel, allowing the display apparatus to be thinner.

Furthermore, since the end surfaces of the light guides are arranged along the specific arc on the plane orthogonal to the long edge direction of the light guides, the light source unit can be applied to any curved display panel by appropriately adjusting the curvature radius or the shape of the specific arc according to the curvature radius of the display panel.

The light source section in the light source unit according to the present embodiment includes the flexible substrate curved along the arc and the LEDs mounted on the curved surface of the curved substrate.

By including the flexible substrate curved along the arc, the light source unit eliminates the need to prepare a new substrate depending on the curvature radius of a desired curved display panel.

Each of the LEDs in the light source unit according to the present embodiment has a light emitting surface orthogonal to the curved surface of the curved substrate. The LEDs are disposed with the light emitting surfaces facing the end surfaces of the light guides.

In the light source unit, the curved surface is the convex surface (outer surface) or the concave surface (inner surface), which is the surface opposite to the convex surface, of the curved substrate. The LEDs are so-called side emitting LEDs each having the light emitting surface orthogonal to the curved surface of the substrate. As including the side emitting LEDs, the present embodiment can be applied to various display panels each having a different curvature radius, because the LEDs can be disposed with the light emitting surfaces thereof facing the end surfaces of the light guides by only changing the degree of curvature of the flexible substrate depending on the curvature radius of the desired display panel.

The display apparatus according to the present embodiment includes the light source unit according to the present embodiment and the display panel curved along the arc.

It is possible to achieve, as the display apparatus according to the present embodiment, a display apparatus including a display panel increased in reliability in terms of damage prevention by including therein the light source unit according to the present embodiment. It is also possible to achieve a thinner display apparatus. Furthermore, it is possible to use a display panel having a desired curvature radius.

### REFERENCE SIGNS LIST

10 Display panel
20 Light guide
21 End surface
30 Chassis
31 Reflection sheet
40 Substrate
41 LED
42 Light emitting surface
43 Light source section
401 Curved surface
50 Light guide unit
60 Light source unit
100 Display apparatus

1. A light source unit comprising:
a light source section; and
a light guide unit including a plurality of elongated light guides arranged side-by-side, the light guides having end surfaces through which light from the light source section enters the light guides, wherein
the end surfaces of the light guides are arranged along a specific arc on a plane orthogonal to a long edge direction of the light guides.

2. The light source unit according to claim 1, wherein
the light source section includes:
a flexible substrate curved along the specific arc; and
a plurality of LEDs mounted on a curved surface of the curved substrate.

3. The light source unit according to claim 2, wherein
each of the LEDs has a light emitting surface orthogonal to the curved surface of the curved substrate, and
the light emitting surfaces face the end surfaces of the light guides.

4. A display apparatus, comprising:
the light source unit according to claim 1; and
a display panel curved along the specific arc.
